(19) United States
(12) Patent Application Publication
(10) Pub. No.: US 2017/0221297 A1
(43) Pub. Date: Aug. 3, 2017

(54) INFORMATION PROCESSING APPARATUS, INFORMATION PROCESSING SYSTEM, INFORMATION PROCESSING METHOD AND COMPUTER-READABLE STORAGE MEDIUM

(71) Applicant: CASIO COMPUTER CO., LTD., Tokyo (JP)

(72) Inventor: Satoru Kakegawa, Hamura-shi (JP)

(21) Appl. No.: 15/380,632

(22) Filed: Dec. 15, 2016

(30) Foreign Application Priority Data
Jan. 29, 2016 (JP) 2016-015743

(51) Int. Cl. G07F 17/32

(52) U.S. Cl. CPC G07F 17/329; G07F 17/3211; G07F 17/3227; G07F 17/3244

(57) ABSTRACT

According to one embodiment, an information processing apparatus includes a signage device and a cash register. The signage device executes a lottery, based on a presentation of a card medium in which lottery information is stored, and causes the card medium to store prize information which is obtained by executing the lottery. The cash register registers information of a purchased commodity, executes settlement on a result of the registration by using the card medium which stores amount-of-money information for commodity purchase, causes the medium to store lottery information, which enables the lottery, in the card medium in accordance with a content of the settlement, and presents, based on the card medium storing the prize information, a prize.

### CROSS-REFERENCE TO RELATED APPLICATIONS

This application is based upon and claims the benefit of priority from prior Japanese Patent Application No. 2016-015743, filed Jan. 29, 2016, the entire contents of which are incorporated herein by reference.

### BACKGROUND OF THE INVENTION

1. Field of the Invention

The present invention relates to an information processing apparatus, an information processing system, an information processing method and a computer-readable storage medium.

2. Description of the Related Art

Technology has been proposed which enables to issue various kinds of lottery tickets in a store such as a convenience store (e.g. patent document 1 (Jpn. Pat. Appln. KOKAI Publication No. H6-119366)).

In many convenience stores, etc., as a kind of campaign for sales promotion, such a service exists that a customer is allowed to draw a lottery card in a box in units of a predetermined purchase amount, and a commodity or a privilege, which is described on the drawn card, is offered to the customer.

In such techniques including the technique disclosed in the above-described patent document 1, lotteries performed in stores are mainly based on paper media. In this case, there is a problem that lottery cards or the like, which are necessary for the lotteries, have to be prepared on the store side each time such a service is provided.

The present invention has been made in consideration of the above-described circumstance, and the object of the invention is to realize easy enjoyment of lottery services.

### BRIEF SUMMARY OF THE INVENTION

According to one embodiment, there is provided an information processing apparatus including a registration unit configured to register information of a purchased commodity; a settlement unit configured to execute settlement on a result of the registration by using a medium which stores amount-of-money information for commodity purchase; a first controller configured to cause the medium to store lottery information, which enables a lottery, in the medium in accordance with a settlement content in the settlement unit; a second controller configured to execute the lottery, based on the medium in which the lottery information is stored, and to cause the medium to store prize information which is obtained by executing the lottery; and a prize presenting unit configured to present, based on the medium storing the prize information obtained by executing the lottery, a prize.

According to the present invention, it is possible to realize easy enjoyment of lottery services.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a view illustrating a configuration of connection of the entirety of a lottery system according to an embodiment of the present invention.

FIG. 2 is a perspective view illustrating a configuration of the external appearance of a signage device 10 according to the embodiment.

FIG. 3 is a block diagram illustrating a functional configuration of, mainly, electronic circuitry of the signage device according to the embodiment.

FIG. 4 is a block diagram illustrating a functional configuration of, mainly, electronic circuitry of a cash register according to the embodiment.

FIG. 5 is a flowchart illustrating the content of an accounting process in the cash register according to the embodiment.

FIG. 6 is a flowchart illustrating the content of a content output and a lottery process in the signage device according to the embodiment.

FIG. 7 is a view illustrating an example of content which is displayed on a signage board as a lottery result in the signage device according to the embodiment.

FIG. 8 is a view illustrating an example of content which is displayed on the signage board as a lottery result in the signage device according to the embodiment.

FIG. 9 is a view illustrating a display example in connection with purchase (exchange) of a prize commodity as a result of a lottery, which is displayed on the cash register according to the embodiment.

FIG. 10 is a view illustrating a display example in connection with non-purchase (non-exchange) of a prize commodity as a result of a lottery, which is displayed on the cash register according to the embodiment.

### DETAILED DESCRIPTION OF THE INVENTION

Hereinafter, with reference to the accompanying drawings, a detailed description will be given of an embodiment of the present invention in a case in which the invention is applied to, for example, a lottery system in a convenience store.

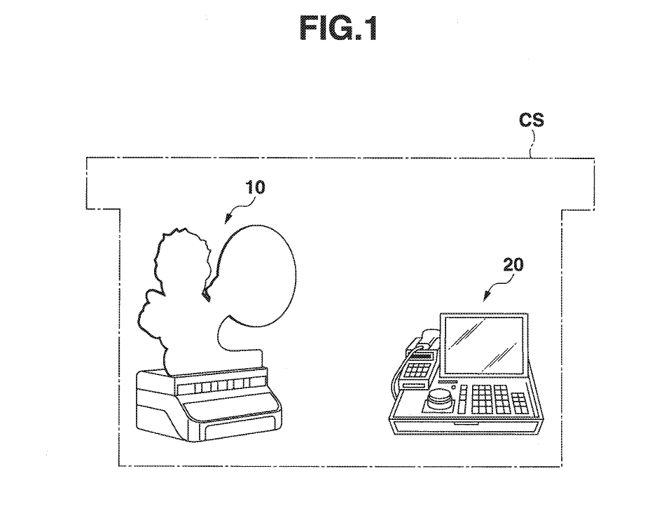

FIG. 1 is a view illustrating a configuration of connection of the entirety of the lottery system. In a convenience store CS, a signage device 10 and a cash register 20 are disposed.

The signage device 10 employs projector technology. While the signage device 10 normally functions as an electronic mannequin which plays back advertisement content of goods, etc., the signage device 10 executes a lottery based on lottery information which was issued.

The cash register 20 executes an accounting process at a time of commodity purchase, and issues lottery information in accordance with a purchase amount.

In the present embodiment, it is assumed that a lottery service is executed only for a customer who uses a prepaid card of electronic money (hereinafter referred to as “card”) using NFC (Near Field Communication) technology, which is effective in the chain system of this convenience store. This card can be caused to nonvolatilely store lottery information indicating how many times lotteries can be performed, and prize information as a result of a winning lottery.

In addition, instead of the use of the card, an application program, which is substituted for the card, may be pre-installed in a mobile information device, such as a smartphone or a tablet possessed by a customer, the mobile information device including a so-called “Osaifu-keitai” (trademark) function (mobile wallet function). Thereby, with the use of an NFC mechanism which the mobile information device includes, the same environment of use as with the above-described card can be realized.

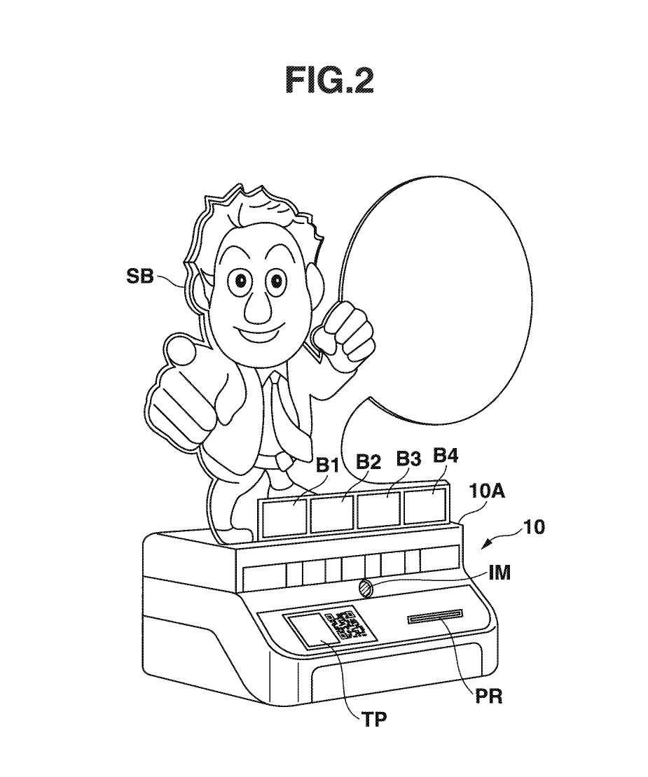

FIG. 2 is a perspective view illustrating a configuration of the external appearance of the signage device 10. As described above, the signage device 10 is an electronic mannequin which employs projector technology. A signage board SB, which functions as a replaceable screen, is provided upright on a front-end side of the top surface of a device housing 10A. This signage board SB is composed of a milk-white semitransparent plate having an arbitrary shape. The semitransparent plate is disposed so as to be included in a normally rectangular projectable range of the signage device 10.

An optical image that is emitted from a projection lens of a rear projection method, which is provided on the top surface of the device housing 10A, is projected from the rear side of the signage board SB. Thereby, the signage board SB displays, for example, an image as illustrated in the Figure.

A plurality of, or four in this embodiment, operation buttons are projected on a lower part of the signage board SB. If any one of these buttons is touch-operated by a viewer, the touch-operation position can be detected by a line-shaped infrared sensor array (not shown) with directivity, which is disposed on a board attachment base portion.

In addition, on the front surface of the device housing 10A, there are provided an imaging portion IM for photographing an environment on the front side of the signage device 10, an NFC unit TP, in close proximity to which the card is moved, and a print unit PR which prints out memorandum information of a prize after a lottery operation.

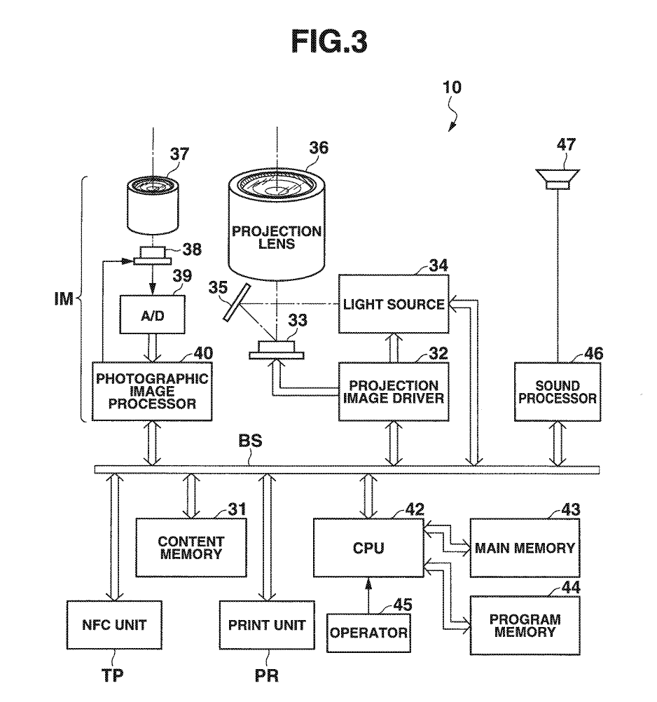

Next, referring to FIG. 3, the functional configuration of, mainly, electronic circuitry of the signage device 10 is described. A plurality of content data, which are prepared for various kinds of goods, campaigns and lotteries, are stored in a content memory 31. Each of the content data is composed of image data, sound data, control data, etc. The image data in the content data is read out by a CPU 42 (to be described later), and is sent to a projection image driver 32 via a system bus BS.

The projection image driver 32 display-drives a micromirror element 33 which is a display element, by higher time-division drive obtained by multiplication of a frame rate following a predetermined format, for example, 120 [frames/second], a division number of a color component, and the number of display gradations, in accordance with the image data that was sent.

The micromirror element 33 displays and operates, by an individual high-speed ON/OFF operation, each inclination angle of a plurality of micromirrors corresponding to, for example, WXGA (lateral 1280 pixels×longitudinal 768 pixels) arranged in an array shape, thereby forming an optical image by reflection light.

On the other hand, a light source 34 cyclically emits R, G, B primary color lights in time division. The light source 34 includes an LED as a semiconductor light-emitting device and repeatedly emits R, G, B primary color lights in time division. The LED of the light source 34 may include an LD (semiconductor laser) and an organic EL element as the LED in a broad sense. The primary color lights from this light source 34 are reflected by a mirror 35 and applied to the micromirror element 33.

Then, the reflected light from the micromirror element 33 forms an optical image. The formed optical image passes through a projection lens 36 and is projected onto the back side of the signage board SB.

The imaging portion IM includes a wide-angle photographic lens portion 37 which faces in a frontal direction of the signage device 10, and a CMOS image sensor 38 which is a solid-state imaging device disposed at a focus position of the photographic lens portion 37.

An image signal obtained by the CMOS image sensor 38 is digitized by an A/D converter 39 and then sent to a photographic image processor 40. This photographic image processor 40 scans and drives the CMOS image sensor 38 for execution of a photographing operation to convert image data obtained by photographing into a data file, and, thus, to transmit the data file to a CPU 42 (to be described below).

The CPU 42 controls all operations of the above circuits. The CPU 42 is connected directly to a main memory 43 and a program memory 44. The main memory 43 is composed of an SRAM, for example, and functions as a work memory of the CPU 42. The program memory 44 is composed of an electrically rewritable nonvolatile memory, such as a flash ROM, and stores operation programs to be executed by the CPU 42, various standardized data items, and the like.

The CPU 42 reads the operation program, standardized data, and the like stored in the program memory 44, develops and stores the read program, data, and the like in the main memory 43, and executes the program, thereby executing overall control on the signage device 10.

The CPU 42 carries out various projection operations according to an operation signal from an operator 45. This operator 45 accepts key operation signals of some operation keys including a power key, which are provided on the main body of the signage device 10, or accepts a detection signal from the above-described infrared sensor array, which detects an operation on a button that is virtually projected on a part of the signage board SB, and sends a signal corresponding to the accepted operation to the CPU 42.

The CPU 42 is further connected to a sound processor 46, the above-described NFC unit TP and print unit PR through the system bus BS.

The sound processor 46 includes a sound source circuit of a PCM sound source or the like and converts sound data in content data, which is read from the content memory 31 during the projection operation, to analog data, and drives a speaker 47 to produce sound or generate a beep sound or the like if necessary.

The NFC unit TP reads out lottery information stored in the above-described card or the like, when the card or like has been moved to the proximity to the NFC unit TP. In addition, when a commodity has been offered as a prize as a result of a winning lottery, the NFC unit TP writes the commodity information to the card.

The print unit PR prints out, as a memorandum, the commodity information of the prize after the lottery was executed.

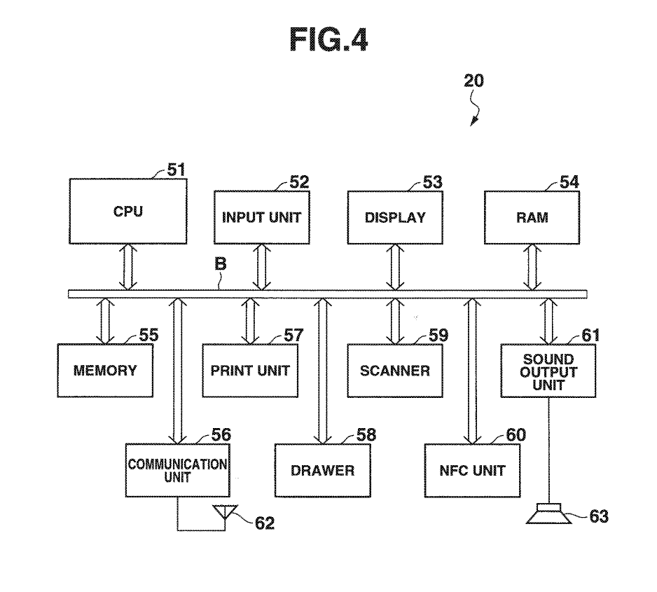

FIG. 4 is a block diagram illustrating the configuration of the cash register 20. As illustrated in FIG. 4, the cash register 20 is configured to include a CPU 51, an input unit 52, a display 53, a RAM 54, a memory 55, a communication unit 56, a print unit 57, a drawer 58, a scanner 59, an NFC unit 60, and a sound output unit 61. These components are connected via a bus B.

The CPU 51 reads out an operation program stored in the memory 55, develops the operation program on a work area of the RAM 54, and executes overall control of the respective components in accordance with the operation program.

The input unit 52 includes a keyboard for a cash register, which includes various function keys such as a power key, cursor keys, character/numeral input keys, and a sub-total key for instructing the end of sales registration. The input unit 52 sends key operation signals of these keys to the CPU 51.

The display 53 is composed of a liquid crystal display panel or an organic EL panel. The display 53 displays various screens under the control of the CPU 51.

The RAM 54 temporarily develops and stores the operation program and various fixed data, which were read out from the memory 55 by the CPU 51.

The memory 55 is composed of, for example, a flash nonvolatile memory. The memory 55 stores the operation program which is executed by the CPU 51, and various fixed data.

The communication unit 56 is composed of a modem, a router, a network card, etc. The communication unit 56 is wirelessly connected to a server apparatus (not shown in FIG. 1) via an antenna 62 which is connected to the communication unit 56. Thereby, the communication unit 56 transmits/receives data in a case in which the cash register 20 is caused to function as a POS (Point of Sales) terminal.

The print unit 57 is composed of, for example, a heat-sensitive paper printer. The print unit 57 prints out prices, sales data, etc. on heat-sensitive roll paper for receipts and journals.

The drawer 58 is a drawer for storing cash such as coins and banknotes. The drawer 58 is opened/closed as needed, in accordance with instructions of the CPU 51.

The scanner 59 includes a bar code reader or a bar code scanner, which reads a bar code that is printed on or attached to a commodity.

The NFC unit 60 reads out or writes data from or to a card or the like, which is moved to the proximity to the NFC unit 60, by NFC technology.

The sound output unit 61 includes a D/A converter, an amplifier, etc. A speaker 63 is connected to the sound output unit 61. The sound output unit 61 digitizes audio data which is given under the control of the CPU 51, and causes the speaker 63 to produce sound with increased volume.

Incidentally, an illustration and a description are omitted of a circuitry configuration of hardware of the card which is used by a customer who uses the above-described convenience store CS.

Next, an example of the operation of the above embodiment will be described.

In the meantime, in the example of the operation below, it is assumed that, only when a customer purchased a commodity by using a card in the convenience store CS, a point service is provided, and lottery information is issued which enables the customer to draw a one-time lottery for a predetermined purchase amount, for example, 500 yen.

At first, an operation is described in a case in which the customer purchases a commodity by using the card in the convenience store CS. In this case, it is assumed that an amount of money, which is necessary for purchasing the commodity, is charged in advance in the card, and that information relating to a lottery is not stored at this time point.

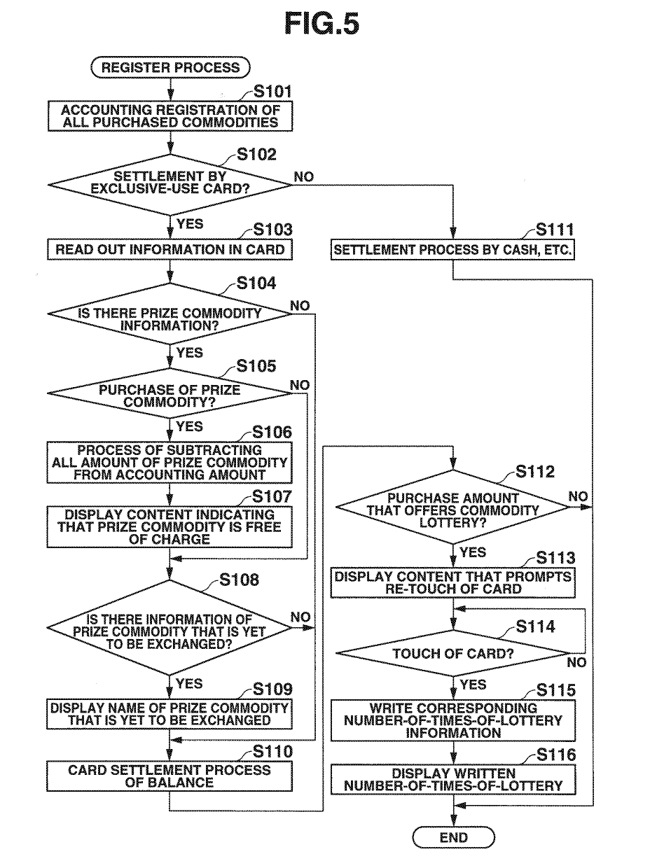

FIG. 5 illustrates an accounting process which the CPU 51 of the cash register 20 executes when the customer purchases a commodity by the cash register 20 of the convenience store CS. To begin with, the commodity information of all commodities purchased by the customer is read by the scanner 59 and registered, and an operation of performing accounting settlement is accepted by the input unit 52 (step S101).

It is necessary to select, by the input unit 52, a method of settlement by this process, that is, to select one of a card, cash, a debit card, and a credit card as a method of settlement. It is determined whether the card was selected or not, by this selection operation (step S102).

If it is determined that an operation of conducting settlement by a method other than the card, that is, a method of cash, the credit card or the like, was executed (No in step S102), the CPU 51 executes the settlement process by the method corresponding to the selected operation (step S111), and terminates the process of FIG. 5.

In step S102, if the CPU 51 determines that the card was selected as the settlement method (Yes in step S102), the CPU 51 executes, by using the display 53, such display as to prompt a touch of the card to the NFC unit 60, and reads out information stored in the card that is touched to the NFC unit 60 in accordance with such display (step S103). Then, the CPU 51 determines whether prize commodity information as a result of the lottery service is stored in addition to amount-of-money information (step S104).

Here, if it is determined that the prize commodity information as the result of the lottery service is not stored (No in step S104), the CPU 51 executes a settlement process of subtracting the purchase amount of settlement of this time from the amount-of-money information stored in the card, and updating and storing the balance (step S110).

Subsequently, the CPU 51 determines whether the amount after the settlement in the immediately preceding step Step S110 has reached a purchase amount that enables a lottery (step S112).

Here, if it is determined that the amount after the settlement has not reached the purchase amount that enables a lottery (No in step S112), the CPU 51 terminates the process of FIG. 5.

If it is determined in step S112 that the amount after the settlement has reached the purchase amount that enables a lottery (Yes in step S112), the CPU 51 executes, by using the display 53, such display as to prompt once again a touch of the card to the NFC unit 60 (step S113), and stands by for an actual touch of the card to the NFC unit 60 (step S114).

If the CPU 51 determines that the card was touched to the NFC unit 60 (Yes in step S114), the CPU 51 writes number-of-times-of-lottery information, which corresponds to the purchase amount, into the card (step S115).

In addition, the CPU 51 causes the display 53 to display the content of the number-of-times-of-lottery information that was written in the card, and informs the customer of the convenience store CS that the lottery service on the signage device 10 is available by the commodity purchase of this time (step S116). Then, the CPU 51 terminates the process of FIG. 5.

Next, a description will be given of an operation in a case of performing a lottery on the signage device 10 by using the card which stores the number-of-times-of-lottery information.

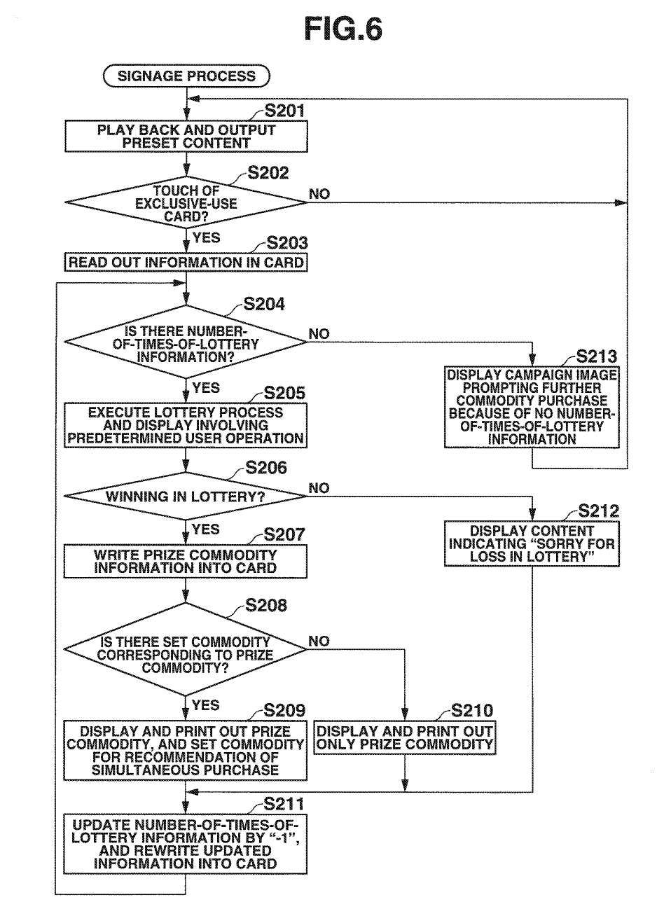

FIG. 6 illustrates a control operation which the CPU 42 executes in the signage device 10. In FIG. 6, the CPU 42 reads out content data, which is preset at this time point, from the content memory 31, and plays back the content data. Thus, the CPU 42 causes an image to be emitted from the projection lens 36 and projected onto the signage board SB, and causes the speaker 47 to produce sound (step S201).

In addition, the CPU 42 determines whether the card is touched to the NFC unit TP (step S202). If the CPU 42 determines that the card is not touched to the NFC unit TP (No in step S202), the CPU 42 returns to the process from step S201.

In this manner, the process of steps S201 and S202 is repeated. While the playback of the preset content is continued, the CPU 42 stands by for a touch of the card to the NFC unit TP.

Then, at a time point when the touch of the card to the NFC unit TP was determined (Yes in step S102), the CPU 42 reads out the number-of-times-of-lottery information from the card (step S203), and determines whether at least a one-time lottery is performed or not, according to whether the number-of-times-of-lottery information was actually read out from the card or not (step S204).

The subsequent process is executed in the state in which the card is kept in contact with the NFC unit TP. Here, if the CPU 42 determines that the number-of-times-of-lottery information cannot be read out from the card and even a one-time lottery cannot be performed (No in step S204), the CPU 42 reads out content data including a campaign image, which prompts further commodity purchase, from the content memory 31, because of the absence of the number-of-times-of-lottery information. Further, the CPU 42 executes, for a predetermined time, the projection display on the signage board SB by the projection lens 36, and the output of sound from the speaker 47 (step S213), and then returns to the process from step S201 in preparation for the next use by the customer.

In step S204, if the CPU 42 determines that the number-of-times-of-lottery information can be read out and at least a one-time lottery can be performed (Yes in step S204), the CPU 42 executes the lottery process and display involving a predetermined user operation (step S205).

At this time, the CPU 42 plays back content data which was prepared in advance for lotteries, and determines a win/loss in a lottery by using a random number.

As a result of the lottery, the CPU 42 determines a win/loss (step S206). If the CPU 42 determines a loss in the lottery (No in step S206), the CPU 42 reads out content data indicating “sorry for loss in lottery” from the content memory 31, and plays back the content data (step S212).

In addition, the CPU 42 causes the NFC unit TP to overwrite and update the content of the card to such a content that the number-of-times-of-lottery information, which was read out in the preceding step S203, was updated by “−1” (step S211), and the CPU 42 returns to the process from step S204 in preparation for the next lottery.

In step S206, if the CPU 42 determines a win in the lottery (Yes in step S206), the CPU 42 writes prize commodity information to the card by the NFC unit TP (step S207). Further, the CPU 42 determines whether a commodity, which forms a set with the prize commodity, is prepared in advance or not (step S208).

Here, if the CPU 42 determines that there is a set commodity corresponding to the prize commodity (Yes in step S208), the CPU 42 reads out from the content memory 31 content data for display which prompts simultaneous purchase of the set commodity, and for display of the prize commodity, and plays back the content data. In addition, the CPU 42 causes the print unit PR to issue a memorandum paper sheet describing the same content, that is, the information of the prize commodity, and the recommended set commodity (step S209).

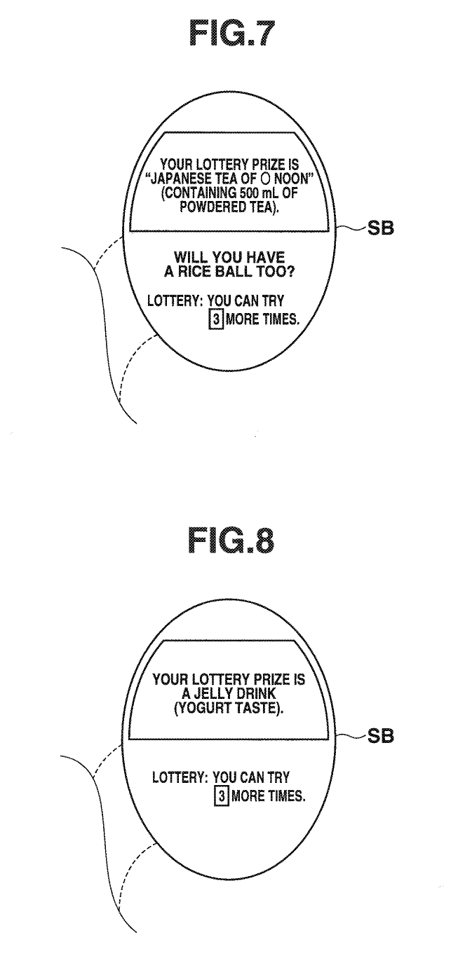

FIG. 7 is a view illustrating an example of a display state at this time, in which the information of the prize commodity and the information of the set commodity are combined and displayed by being projected onto a part of the signage board SB.

In FIG. 7, a message indicating that the prize commodity is a drink “Japanese tea of ◯ noon” (containing 500 ml of powdered tea) is mainly displayed, and purchase of “rice ball” as a set commodity is recommended by a message “Will you have a rice ball too?”.

Furthermore, a message indicating that “3” more lotteries are still available after the lottery of this time is also displayed.

In step S208, if the CPU 42 determines that there is no commodity which forms a set with the prize commodity (No in step S208), the CPU 42 reads out content data for display of only the prize commodity, and plays back this content data. In addition, the CPU 42 causes the print unit PR to issue a memorandum paper sheet describing the same content, that is, the information of the prize commodity (step S210).

FIG. 8 is a view illustrating an example of a display state at this time, in which the information of the prize commodity is displayed by being projected on a part of the signage board SB. In FIG. 8, a message indicating that the prize commodity is a drink “Jelly drink (yogurt taste)” is displayed, and a message indicating that “3” more lotteries are still available after the lottery of this time is also displayed.

After the display process of step S209 or step S210, the CPU 42 causes the NFC unit TP to overwrite and update the content of the card to such a content that the number-of-times-of-lottery information, which was read out in the preceding step S203, was updated by “−1” (step S211), and the CPU 42 returns to the process from step S204 in preparation for the next lottery.

In this manner, in the signage device 10, a lottery is executed by the number of times based on the number-of-times-of-lottery information prestored in the card, which is touched to the NFC unit TP, and the information of a prize commodity that is a winning lottery prize is stored in the card.

Next, a description is given of a process in a case in which a customer, who possesses the card that stores the information of the prize commodity, actually purchases commodities including this prize commodity, and executes settlement by using this card.

In the process of FIG. 5, when the customer purchases commodities by the cash register 20, the commodity information of all commodities purchased by the customer is first read by the scanner 59 and registered, as described above, and an operation of performing accounting settlement is accepted by the input unit 52 (step S101).

If the settlement by the card is selected by this process (Yes in step S102), the CPU 51 determines this, and then reads out the information stored in the card that is touched to the NFC unit 60 (step S103). Then, the CPU 51 determines whether prize commodity information as a result of the lottery service is stored in addition to the amount-of-money information (step S104).

Here, if the CPU 51 determines that the prize commodity information as the result of the lottery service is stored (Yes in step S104), the CPU 51 then determines whether the prize commodity was purchased or not, according to whether the prize commodity information, which is stored in the card, is included in the information of commodities registered in the preceding step S101 (step S105).

If the CPU 51 determines that the prize commodity information is included and that the prize commodity was purchased (Yes in step S105), the CPU 51 executes a subtraction process of subtracting the amount of the prize commodity from the total accounting amount (step S106).

In addition, the CPU 51 informs the customer, by display on the display 53, that, as regards the calculation of the prize commodity, this prize commodity was processed as a free-of-charge commodity (step S107).

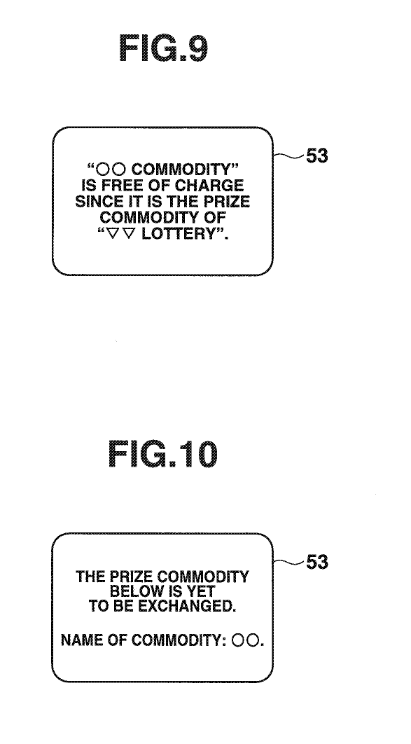

FIG. 9 illustrates an example of an image displayed on the display 53 of the cash register 20 at this time, the image showing that since the purchased “◯◯ commodity” is a prize commodity of “ [symbol] lottery”, the purchased “◯◯ commodity” was settlement-processed as a free-of-charge commodity, and the exchange was completed.

In the meantime, when a plurality of prize commodities of winning lotteries are included in the purchased commodities, such display is effected that the plural prize commodities were settlement-processed as free-of-charge commodities, by displaying these commodities on one screen or on a plurality of divisional screens in accordance with the display capacity of the display 53.

In step S105, if the CPU 51 determines that the information of the prize commodity is not included in the information of the purchased commodities, and that the prize commodity was not purchased (No in step S105), the CPU 51 does not execute the process of steps S106 and S107.

Thereafter, the CPU 51 determines whether the information of the prize commodities, which is stored in the card, includes a commodity which is not included in the purchased commodities of this time, that is, whether there is a commodity which is a prize commodity of a winning lottery and is yet to be exchanged (step S108).

Here, only in the case in which the information of the prize commodity, which is yet to be exchanged, is stored in the card (Yes in step S108), the name of the prize commodity, which is yet to be exchanged, is displayed on the display 53 (step S109).

FIG. 10 illustrates an example of an image displayed on the display 53 of the cash register 20 at this time, the image showing that a prize commodity “◯◯”, which is stored in the card, is not included in the purchased commodities, and the exchange of this prize commodity has not yet been completed.

In step S108, if the CPU 51 determines that the information of the prize commodity, which is yet to be exchanged, is not stored in the card (No in step S108), the CPU 51 does not execute the process of step S109.

Thereafter, the CPU 51 advances to the above-described step S110, and executes the settlement process of subtracting the purchase amount of the commodities purchased by the settlement of this time, excluding the amount of the prize commodity, from the amount-of-money information stored in the card, and updating and storing the balance.

Subsequently, the CPU 51 executes the process of the above-described step S112 onwards in accordance with the purchase amount, and issues further number-of-times-lottery information in accordance with the amount of purchase of this time.

As has been described above in detail, according to the present embodiment, without preparing special paper media or the like for lotteries, it is possible to enable customers to easily enjoy lottery services, while reducing the load on the side of stores such as convenience stores.

Additionally, in this embodiment, distributed processes are executed by an apparatus in which the cash register 20 and the signage device 10 are physically spaced apart. The cash register 20 is configured to execute registration of a necessary condition for a lottery, to execute settlement, and to execute settlement at a time of purchasing a commodity which corresponds to a lottery result. The signage device 10 is configured to actually execute a lottery, and to provide, when there is a prize commodity of a winning lottery, information of the prize commodity to the customer. It is thus possible to avoid causing trouble to other customers, for example, in accounting processes at the cash register.

Additionally, in this embodiment, processes including a settlement process can be simplified by making use of media using NFC (Near Field Communication) technology, which customers possess in advance.

Additionally, in this embodiment, when a prize commodity was offered by a winning lottery, if another set commodity which forms a set with the prize commodity is registered in advance, the purchase of the set commodity is also recommended. Thereby, in the state in which the customer wins in the lottery, additional sales can be promoted.

Additionally, in this embodiment, as regards the prize commodity of the winning lottery, a memorandum paper sheet relating to this prize commodity can be printed out and presented to the customer. Thus, even when the storage content cannot be confirmed by an exclusive-use card or like as a single body, the customer can easily understand the content, etc. of the prize commodity which is the result of the lottery.

In the meantime, in this embodiment, the signage device 10 was described, by way of example, as being composed of a rear projector using DLP (trademark) (Digital Light Processing) technology. However, in the present invention, image display techniques, etc. are not restricted. For example, devices using backlight-equipped color liquid crystal panels, etc. are similarly applicable.

In the above-described embodiment, the prize information, etc. of the lottery result, is stored in the card. However, the restriction to this is unnecessary. The prize information may be stored in the cash register 20 together with the identification information of the card.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processing apparatus comprising:
a registration unit configured to register information of a purchased commodity;
a settlement unit configured to execute settlement on a result of the registration by using a medium which stores amount-of-money information for commodity purchase;
a first controller configured to cause the medium to store lottery information, which enables a lottery, in the medium in accordance with a settlement content in the settlement unit;
a second controller configured to execute the lottery, based on the medium in which the lottery information is stored, and to cause the medium to store prize information which is obtained by executing the lottery; and
a prize presenting unit configured to present, based on the medium storing the prize information obtained by executing the lottery, a prize.

2. The information processing apparatus of claim 1, wherein processes are executed at positions where the registration unit, the settlement unit, the first controller and the prize presenting unit, on one hand, and the second controller, on the other hand, are physically spaced apart.

3. The information processing apparatus of claim 1, wherein the medium is configured to execute the settlement unit, the first controller, the second controller and the prize presenting unit by using NFC (Near Field Communication) technology.

4. The information processing apparatus of claim 1, further comprising:
a content memory configured to prestore content data which recommends another commodity corresponding to the prize information; and
a content playback unit configured to read out, from the content memory, the content data which recommends the another commodity corresponding to the prize information, and to play back the content data, when the medium is caused to store the prize information.

5. The information processing apparatus of claim 1, further comprising:
a print unit configured to issue a memorandum paper sheet on which the prize information is printed, when the medium is caused to store the prize information.

6. An information processing system comprising a first apparatus and a second apparatus,
the first apparatus comprising:
a registration unit configured to register information of a purchased commodity;
a settlement unit configured to execute settlement on a result of the registration by using a medium which stores amount-of-money information for commodity purchase;
a first controller configured to cause the medium to store lottery information, which enables a lottery, in the medium in accordance with a content of the settlement; and
a prize presenting unit configured to present, based on the medium storing the prize information obtained by executing the lottery, a prize, and
the second apparatus comprising:
a second controller configured to execute the lottery, based on the medium in which the lottery information is stored, and to cause the medium to store prize information which is obtained by executing the lottery.

7. An information processing method comprising:
registering information of a purchased commodity;
executing settlement on a result of the registration by using a medium which stores amount-of-money information for commodity purchase;
causing the medium to store lottery information, which enables a lottery, in the medium in accordance with a content of the settlement;
executing the lottery, based on the medium in which the lottery information is stored;
causing the medium to store prize information which is obtained by executing the lottery; and
presenting, based on the medium storing the prize information obtained by executing the lottery, a prize.

8. A computer-readable non-transitory storage medium which stores a program for causing a computer to execute:
a registration process of registering information of a purchased commodity;
a settlement process of executing settlement on a result of the registration by using a medium which stores amount-of-money information for commodity purchase;
a lottery information providing process of causing the medium to store lottery information, which enables a lottery, in the medium in accordance with a settlement content in the settlement process;
a lottery execution process of executing the lottery, based on the medium in which the lottery information is stored;
a prize information providing process of causing the medium to store prize information which is obtained by executing the lottery; and
a prize presenting process of presenting, based on a presentation of the medium storing the prize information obtained by executing the lottery, a prize.
